(19) United States
(12) Patent Application Publication
(10) Pub. No.: US 2015/0106232 A1
(43) Pub. Date: Apr. 16, 2015

(54) DURATION AND ACCESS BASED SELLING OF PRODUCTS

(71) Applicant: One Kings Lane, Inc., San Francisco, CA (US)

(72) Inventors: Josh Liberson, San Francisco, CA (US); Aurelie Davis, San Francisco, CA (US); Jim Kingsbury, San Francisco, CA (US)

(21) Appl. No.: 14/513,562

(22) Filed: Oct. 14, 2014

Related U.S. Application Data
(60) Provisional application No. 61/891,839, filed on Oct. 16, 2013.

(51) Int. Cl. G06Q 30/06; G06Q 50/00

(52) U.S. Cl. CPC G06Q 30/0613; G06Q 30/0641; G06Q 50/01; G06Q 30/0625
USPC 705/26.41

(57) ABSTRACT

Disclosed are methods, systems, paradigms and structures for duration and access based selling of products. Hypervertical is a concept of offering products for sale through specific channels for specific time periods. An online selling entity creates an online sales event offering products for sale. The online sales event is valid for a predefined duration. While the online sales event is active, access to the products are provided exclusively through the online sales event. However, upon expiry of the online sales event, which causes the online sales event to be deleted and access to the products be revoked, the access to the products is provided through third-party applications, such as search results of a search engine, social networking sites, other third-party websites. The third-party applications present the products as, for example, advertisements, accessing which the user can navigate to the online selling entity to view or purchase the products.

### CROSS REFERENCE TO RELATED APPLICATIONS

This application claims priority from U.S. Provisional Patent Application No. 61/891,839, filed Oct. 16, 2013, entitled “DURATION AND ACCESS BASED SELLING OF PRODUCTS,” which is incorporated by reference in its entirety.

### TECHNICAL FIELD

This disclosure relates to electronic commerce and more specifically to duration and access based selling of products.

### BACKGROUND

In current e-commerce environment, products are offered for sale on the internet using various channels. For example, certain products are offered through third-party websites, merchant websites or both. Further, the products may be offered only for a limited period after which they become unavailable to be bought by the consumer. For example, an online entity can have a “Today's Special Sale” on a daily basis that offers certain specific products for sale every day. A consumer wanting to buy a specific product may have to visit the online entity's website on a particular day otherwise he may lose the opportunity to buy the product he is looking for. Additionally, the probability of the product of being viewed by a significantly higher number of consumers in a day is lesser compared to when the product is available for longer duration. This, typically can also result in a lost opportunity for a potential sale, which can affect both the online selling entity and a vendor who is selling the product through the online selling entity.

One solution to this problem could be to list the product for a longer duration, which increases the probability of the product being seen and therefore, bought by more number of consumers increases. However, the online selling entity may not want to host the product after the expiry of a particular sale event for various reasons, including a policy or strategy that requires them to introduce a new sale event every day.

### SUMMARY

Disclosed are methods, systems, paradigms and structures for duration and access based selling of products. Typically, the chances of a potential sale of product in an online environment is related to the duration for which the product is made available for sale to the consumer, and to the ease of discovering the product online. In at least some embodiments, the chances of selling products in an online environment is improved by using duration and access based selling concept, also referred to as “Hypervertical.”

Hypervertical is a concept of offering products for sale through specific channels for specific time periods. An online sales online application of an online selling entity creates an online sales event offering products for sale. The online sales event is valid for a specific period of time. While the online sales event is active, access to the products are provided exclusively through the online sales event. However, upon expiry of the online sales event, which causes the online sales event to be deleted and access to the products be consequently revoked, the access to the products of the expired online sales event is provided through third-party applications. The third-party applications include search results of a search engine, social networking sites, third-party retailer websites, third-party distributor websites, or other third-party websites. After the online sales event has expired, the product information is published to the third-party applications which presents the product information as, for example, advertisements. A user can navigate to the online sales application by accessing these advertisements to view or purchase these products advertised.

Additionally or alternatively, the products may continue to be listed in the online sales application even after the online sales event has expired. The products may be presented in a directed shopping mode and/or an online shop of the online sales application instead of the online sales event. However, the products are presented in the directed shopping mode and/or online shopping mode only after the online sales event expires. At any given instance, a particular product may either be in the online sales event or in at least one of the directed shopping mode or the online shop. In an embodiment, the online sales event, the directed shopping mode and the online shop have different presentation formats which provide different ways to access the products.

For example, the online sales event is presented as a story to the user. In one possible embodiment, related products are categorized into specific chapters of the story and the products are presented as characters of the story. The story can be based on a theme, a category, an occasion, an event, etc. A graphical user interface (GUI) is generated to present the story in a specific format. The GUI includes separate portions for presenting a story introduction, a table of contents identifying the chapters of the story, chapters having the characters, etc. The user may explore various products by navigating through a story. Different stories may include different products. In an embodiment, the GUI may not provide a facility to search for products. The GUI facilitates exploring the products by visiting various stories created by the online sales application.

On the other hand, the directed shopping mode allows the user to search for products that he or she is interested in. In an embodiment, a directed shopping mode GUI allows the user to specify a particular criterion that is directed towards his/her interest. The GUI includes user interface elements, such as a set of filters, to specify the particular criterion for finding the products.

The online shop presents the products in a GUI having various formats. In one embodiment, a format of the GUI of the online shop may be similar to that of the online sales event. However, unlike the online sales event, the online shop does not expire. Further, the online shop may include all the products of expired sales events or a subset of the products of the expired sales events. Furthermore, at least a subset of the products in the online shop are accessible via the third-party applications.

Accordingly, the online sales application presents the products through specific channels for specific periods. This technique ensures that the products are widely accessible and for longer periods.

Some embodiments of the disclosed technique have other aspects, elements, features, and steps in addition to or in place of what is described above. These potential additions and replacements are described throughout the rest of the specification.

### BRIEF DESCRIPTION OF THE DRAWINGS

FIG. 1 is an environment in which an embodiment of the disclosed technique may operate.

FIG. 2 illustrates an example embodiment of the disclosed techniques.

FIG. 3 is a flow diagram illustrating a process of duration and access based selling of products.

FIG. 4 is a flow diagram illustrating another process of duration and access based selling of products.

FIG. 5, which includes FIGS. 5A, 5B and 5C, illustrates an example GUI for presenting an online sales event as a story.

FIG. 6 is a block diagram of a system for performing the duration and access based selling of products.

FIG. 7 is a block diagram of a processing system that can implement operations of the present disclosure.

### DETAILED DESCRIPTION

References in this description to “an embodiment”, “one embodiment”, or the like, mean that the particular feature, function, or characteristic being described is included in at least one embodiment of the present disclosure. Occurrences of such phrases in this specification do not necessarily all refer to the same embodiment, nor are they necessarily mutually exclusive.

Disclosed are methods, systems, paradigms and structures for duration and access based selling of products. Typically, the chances of a potential sale of product in an online environment is related to the duration for which the product is made available for sale to the consumer, and to the ease of discovering the product online. In at least some embodiments, the chances of selling products in an online environment is improved by using duration and access based selling concept, also referred to as “Hypervertical.”

Hypervertical is a concept of offering products for sale through specific channels for specific time periods. An online sales online application of an online selling entity creates an online sales event offering products for sale. The online sales event is valid for a specific period of time. While the online sales event is active, access to the products are provided exclusively through the online sales event. However, upon expiry of the online sales event, which causes the online sales event to be deleted and access to the products be consequently revoked, the access to the products of the expired online sales event is provided through third-party applications. The third-party applications include search results of a search engine, social networking sites, third-party retailer websites, third-party distributor websites, or other third-party websites. After the online sales event has expired, the product information is published to the third-party applications which presents the product information as, for example, advertisements. A user can navigate to the online sales application by accessing these advertisements to view or purchase these products advertised.

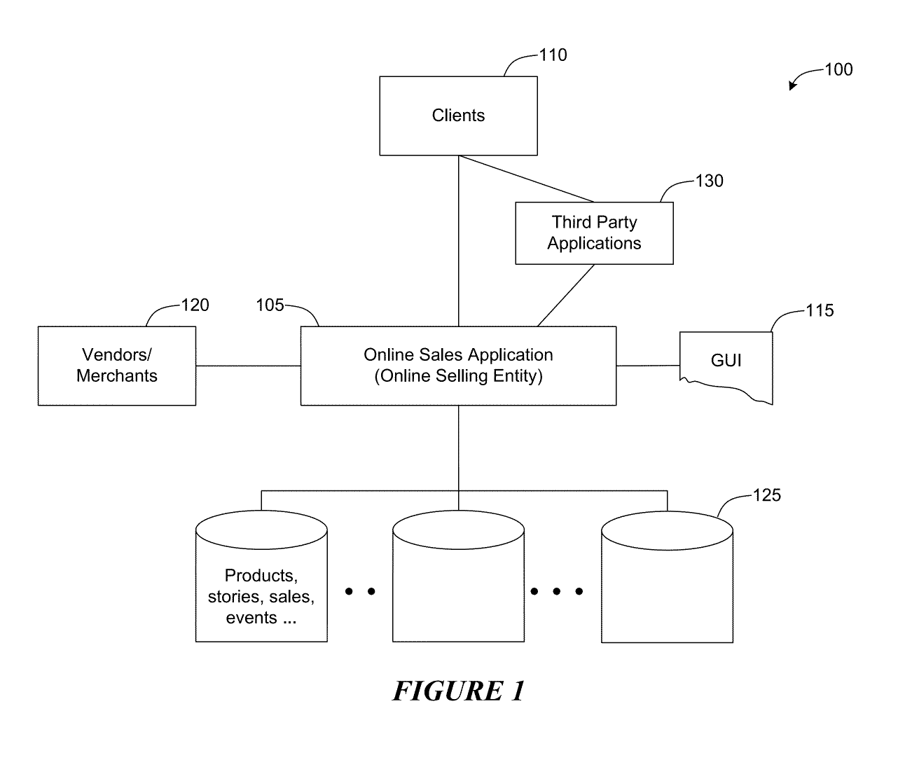

FIG. 1 is an environment in which an embodiment of the disclosed technique may operate. The environment can include an online environment 100 such as e-commerce, web commerce or Internet commerce, where an online selling entity 105 offers products for sale to consumers such as clients 110. The products offered can include products made by or for the online selling entity 105 and/or products from various other vendors or merchants 120. Clients 110 may also access certain products of the online selling entity 105 through third-party applications 130. In at least some embodiments, the online selling entity 105 offers the products for sale based on the Hypervertical concept.

In the Hypervertical concept, the online selling entity 105 offers the products through various channels such as online sales event, a directed shopping mode and an online shop at different times. In at least one embodiment, a set of products are offered exclusively through the online sales event while the online sales event is active. That is, in other words, the set of products are not available through any other channels, either within the online sales application or outside the online sales application, such as third-party applications, while the online sales event is active. After the online sales event expires, the set of products are then made available from at least one of the directed shopping mode or the online shop. Further, the some of the set of products in the online shop can also be accessed via third-party applications 130.

In an embodiment, clients 110 may view or purchase the products from the online selling entity 105 using an online sales application of the online selling entity 105 (Henceforth, “online selling entity” and “online sales application” are used interchangeably.). The online sales application can be implemented as a website, an application (“app”), etc. that can be accessed from a variety of clients 110.

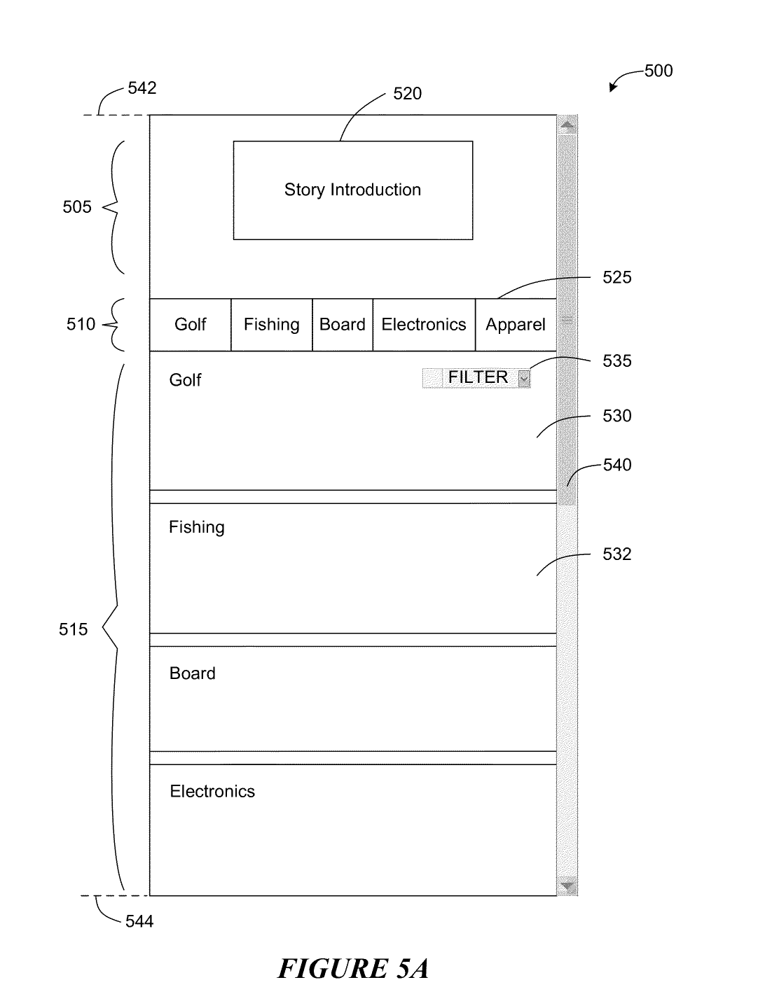

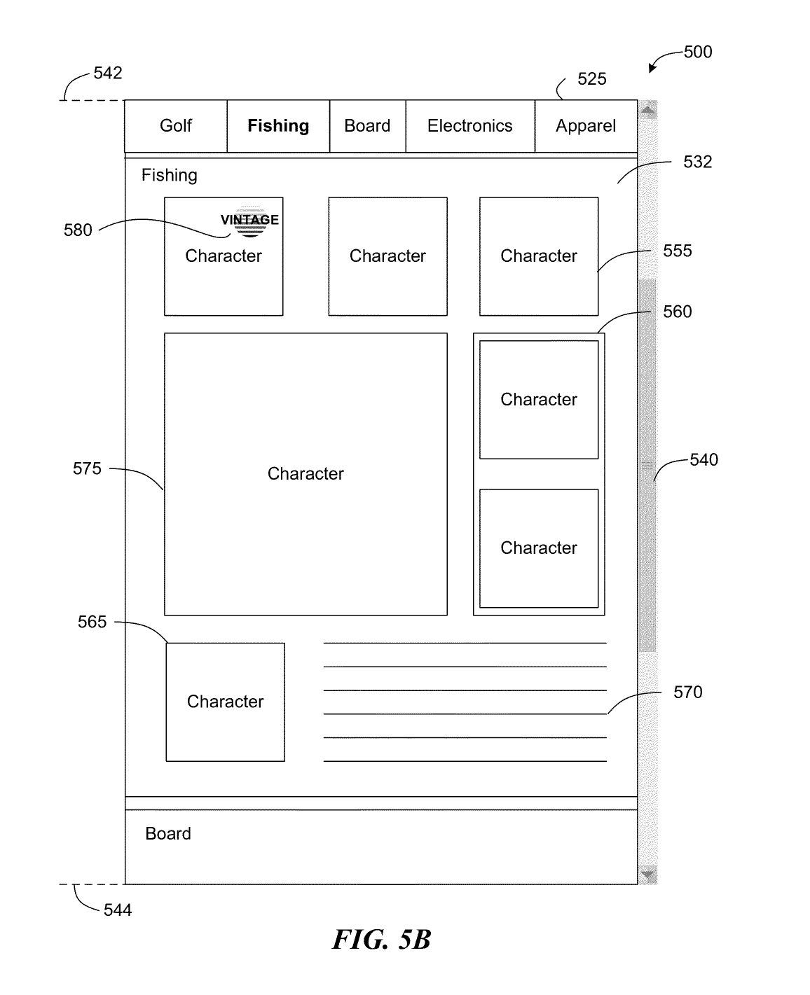

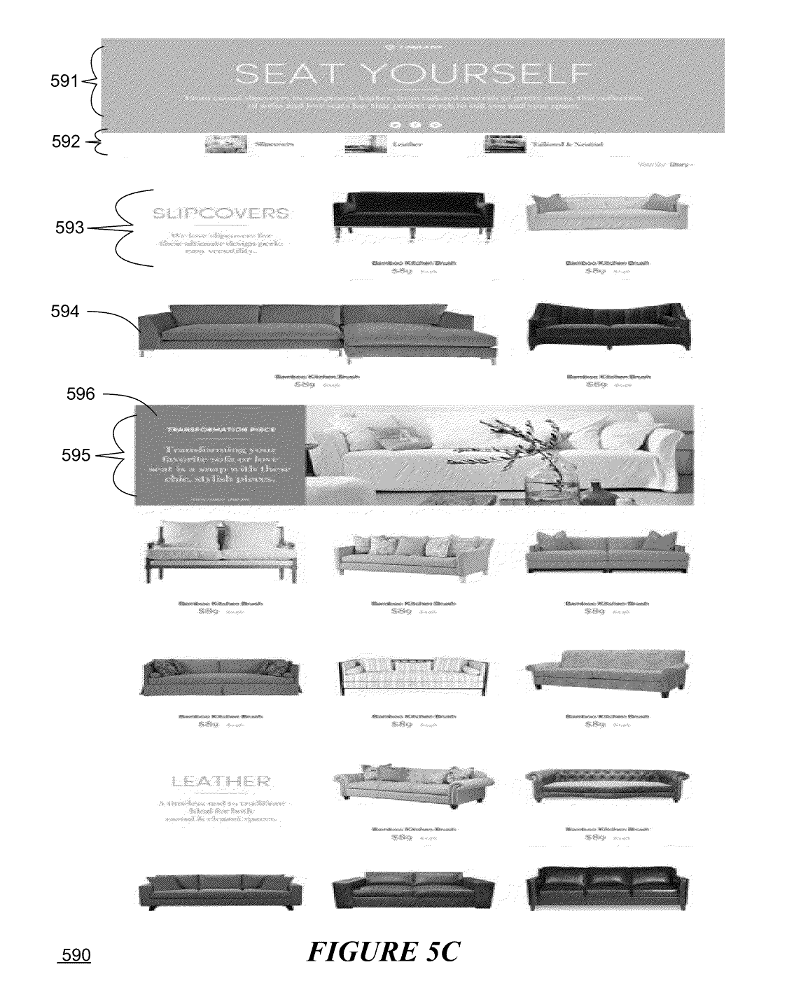

The online selling entity 105 hosts various applications that may be necessary for operating the online environment 100. The online sales application is one such application. The online sales application includes the necessary logic to implement the Hypervertical concept. Further, the online sales application also includes necessary logic to generate graphical user interfaces (GUIs) 115 for presenting the products to clients 110 as an online sales event, in directed shopping mode or as an online shop. In an embodiment, the GUIs 115 for presenting the products in each of the channels can have different formats and provide different navigation techniques for exploring the set of products. Additional details regarding the GUIs 115 are described at least with reference to FIG. 5.

The products offered for sale can include a wide variety, for example, furniture, home improvement goods, apparel, pictures, frames, sculptures, recreational goods, services, etc. The online selling entity 105 provides an online selling platform (for example, via an application programming interface (API)) for vendors or merchants 120 who wish to sell their products via the online selling entity 105. The vendors or merchants 120 may use the API to provide details such as the products, prices for the products, pricing strategies, duration of the sale for the products, any other policies with respect to selling the product that might have to be agreed upon the involved parties. In at least some embodiments, the vendors or merchants 120 may access various other applications hosted on the online selling entity 105 using the API. Further, the online selling entity 105 may also establish policies, such as pricing, profit sharing, type of products, etc., which the vendors or merchants 120 may have to comply with for selling their products using the online selling entity 105.

Storage system 125 can include storage units such as a database. In at least some embodiments, the storage system 125 stores various details regarding inventory of products offered for sale, pricing strategies, sale strategies, stories, themes for stories, concepts for stories, multi-media content for presenting the products and stories, GUI generating applications, user accounts, user profiles, transactions, third-party applications 130 through which the products can be accessed by the users, etc. In an embodiment, any user who wants to view or buy products from the online selling entity 105 may be asked to create a user account with the online selling entity. Further, the user may also be asked to provide other personal details such as age, income, gender, their preferences to types of products, merchants, colors of products, etc. which are stored in as a user profile. The user profile may be used to personalize/customize the set of products presented to a particular user. The online selling entity 105 accesses the storage system 125 to obtain necessary data for operation of the online environment 100.

Clients 110 may view and/or purchase the products offered for sale by the online selling entity 105 by accessing the GUIs 115 rendered by the online sales application. Clients 110 may access the GUIs 115 via various means, including through a website or an app of the online selling entity 105 that allows the users to view and/or purchase the products from the online selling entity 105. Clients 110 can include a plurality of devices such as a computer, a laptop, a mobile phone, a tablet PC, etc.

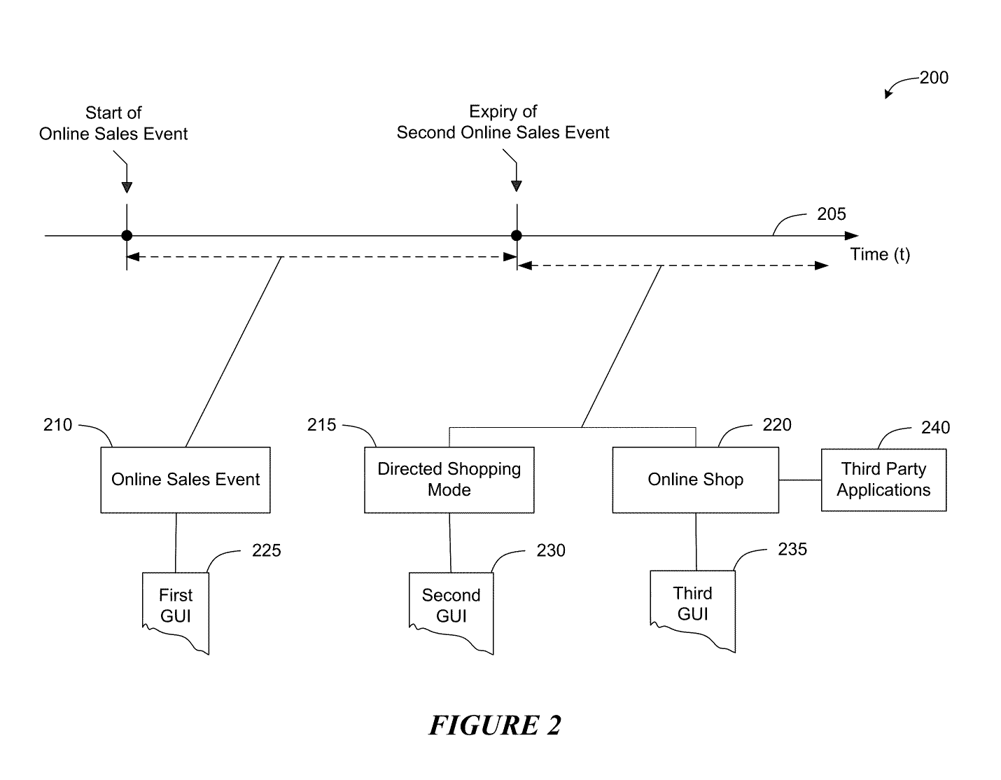

FIG. 2 illustrates an example implementation of duration and access based selling of products, according to an embodiment of the disclosed technique.

The example 200 illustrates the concept of Hypervertical in which a set of products are offered through various channels, such as an online sales event 210, directed shopping mode 215 and an online shop 220, at specific times as indicated using a time axis 205. An online selling entity such as the online selling entity 105 of FIG. 1 creates the online sales event 210 offering a set of products for sale. The online sales event 210 is valid for a specific period of time. While the online sales event 210 is active, access to the set of products are provided exclusively through the online sales application 105 and via the online sales event 210. In other words, a user may not access, view or purchase the set of products through any channel other than the online sales event 210.

Upon expiry of the online sales event 210, the online sales event 210 is deleted, which consequently revokes access to the set of products. However, instead of removing the set of products or revoking access to the set of the products, the set of products are offered for sale through other channels such as the directed shopping mode 215 and/or the online shop 220.

In at least some embodiments, each of the channels present the set of products in different formats and with different objectives. For example, the online sales event 210 presents products (a) that are part of active sales event, (b) as a story to the user, (c) does not provide facility to search for products. The directed shopping mode 215 (a) presents products from the expired online sales events and (b) allows a user to search for products based on a particular criterion. The online shop 220 (a) presents at least some products from the expired online sales events and (b) allows the user to access at least a subset of these products via third-party applications. These various channels are described in further detail in the following paragraphs.

The online sales event 210 is presented as a story to the user. A first graphical user interface (GUI) 225 generates the online sales event 210 in the story format. The story can be based on a theme, a category, an occasion, an event, etc. In presenting the online sales event 210 as a story, related products are categorized into specific chapters of the story and the products are presented as characters of the story. Different stories may include different sets of related products. The user may explore the products by visiting various chapters of a story and/or various stories created by the online sales application. The first GUI 225 may not provide a facility to search for products within the online sales event. That is, the user may not be able to search for a particular product in the online sales event using a search query. The user may view the products by browsing through one or more chapters. Additional details with respect to the first GUI 225 for the online sales event 210 is discussed at least with reference to FIG. 5.

On the other hand, the directed shopping mode 215 allows the user to search for products that he or she is interested in. In an embodiment, a second GUI 230 of the directed shopping mode 215 includes user interface elements, such as a set of filters, that allows the user to specify a particular criterion for finding the products. The particular criterion can be directed towards the interest of the user. For example, the search criteria can include, a theme, a category, a type, a name, an application, or any other properties of the set of products.

The online shop 220 presents the products in a third GUI 235. The third GUI 235 can be of various formats. In one embodiment, a format of the third GUI 235 may be similar to that of the online sales event 210. The online shop 220 may present the set of products in the story format similar to that of the online sales event 210. However, unlike the online sales event 210, the online shop 220 does not expire and contains only products from expired sales events. A user preferring to view the products in the story format may view the set of products through the online shop 220 instead of the directed shopping mode 215.

Further, at least some of the set of products in the online shop 220 can also be accessed via external channels such as third-party applications 240. The third-party applications 240 can include search results of a search engine, social networking sites, third-party retailer websites, third-party distributor websites, or other third-party websites. The product information is published to the third-party applications 240 by the online sales application 105 after the online sale event 210 expires. The products may appear in the third-party applications 240, for example, as a search result or as an advertisement in response to a search performed by the user in a third-party search engine application. In another example, the product may also appear as search results or as similar products in websites of various third-party online selling entities when a user searches for certain products in the websites of the third-party online selling entities. Upon user selection of the product listings on the third-party applications 240, the user is navigated to the online sales application 105 where the products can be viewed or purchased.

The set of products featured in the directed shopping mode 215 and/or the online shop 220 of the online sales application 105 are products from expired online sales events. At any given instance, a particular product may either be featured in the online sales event 210 or in at least one of the directed shopping mode 215 or the online shop 220. Further, in an embodiment, the directed shopping mode 215 may feature all products from all expired online sales events, whereas the online shop 220 may feature only a subset of the products from the expired online sales events. In an embodiment, the subset of the products featured in the online shop 220 may be selected based on various selection criteria. The selection criteria may be defined by a user such as an administrator of the online sales application 105. One example selection criterion can be to include products that may be of special interest to the user, which can be determined based on a user profile of the user.

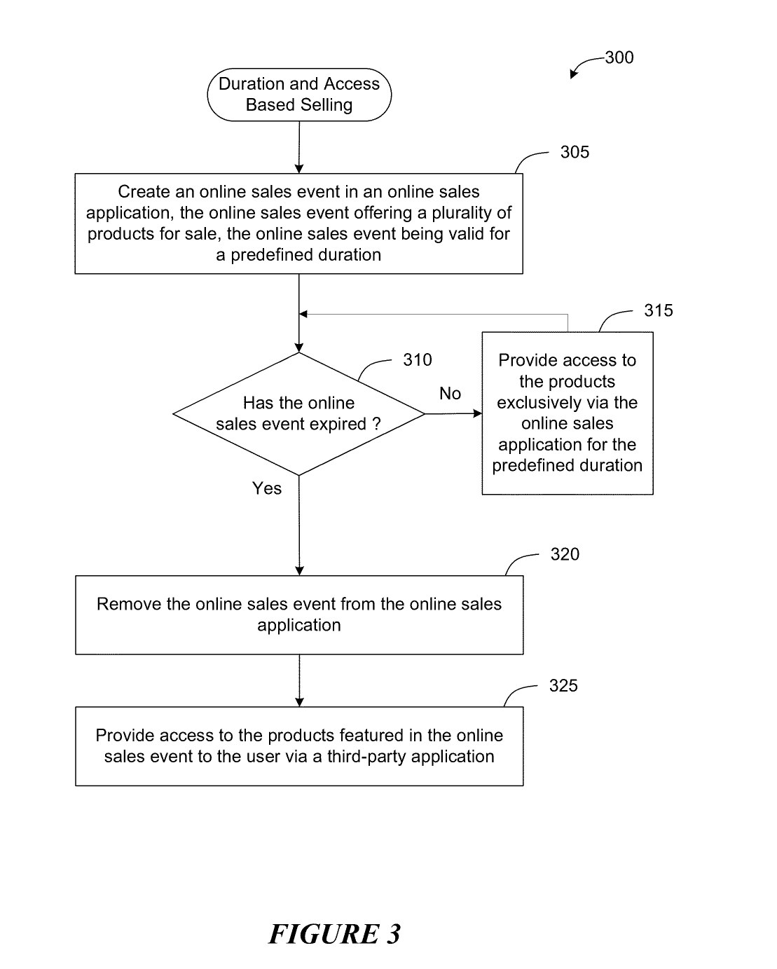

FIG. 3 is a flow diagram illustrating a process of duration and access based selling of products, according to an embodiment of the disclosed technique. The method 300 may be executed in an environment such as the online environment 100 of FIG. 1. At step 305, an online sales application 105 creates an online sales event offering a number of products for sale. The products offered for sale can include products that are made by or for the online selling entity 105, of a specific vendor, a number of vendors, a particular category, theme, occasion, etc. Further, the online sales event may be offered for a predefined period of time, such as an hour, a day, three days, a week, etc.

At step 310, the online sales application 105 determines whether the online sales event has expired. Responsive to a determination that the online sales event has not expired, at step 315, the online sales application 105 continues to provide access to the products exclusively through the online sales event of the online sales application. In other words, a user may not access (view or purchase) the products through any channel other than the online sales event.

On the other hand, responsive to a determination that the online sales event has expired, at step 320, the online sales event is removed from the online sales application. However, the products that featured in the expired online sales event may not be deleted from the online sales application after the online sales event has expired. At step 325, the online sales application 105 provides access to the products that featured in the expired online sales event through third-party applications.

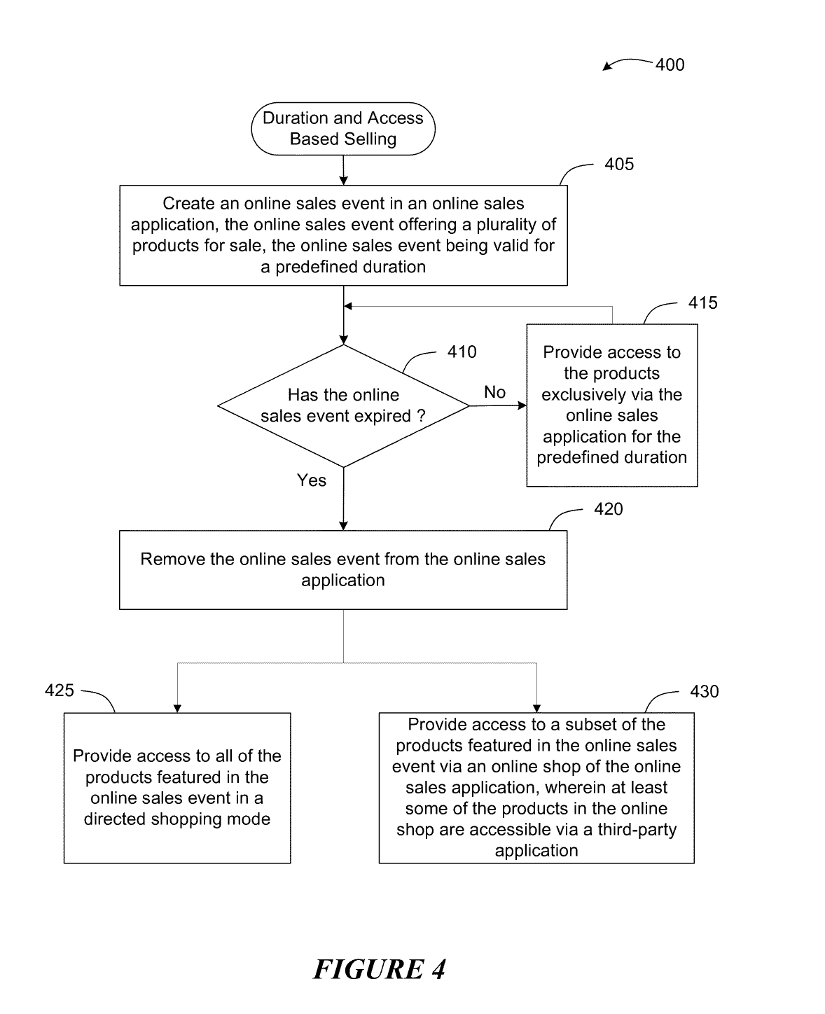

FIG. 4 is a flow diagram illustrating another process of duration and access based selling of products, according to an embodiment of the disclosed technique. The method 400 may be executed in an environment such as the online environment 100 of FIG. 1. At step 405, an online sales application 105 creates an online sales event offering a number of products for sale. The products offered for sale in a particular sale event can include products that are made by or for the online selling entity 105, of a specific vendor, a number of vendors, a particular category, theme, occasion, etc. Further, the online sales event may be offered for a predefined period of time, such as an hour, a day, three days, a week, etc.

At step 410, the online sales application 105 determines whether the online sales event has expired. Responsive to a determination that the online sales event has not expired, at step 415, the online sales application 105 continues to provide access to the products exclusively through the online sales event of the online sales application. In an embodiment, the online sales event is presented in the form of a story. The user may explore various products offered for sale by navigating through the story.

Referring back to determination step 410, responsive to a determination that the online sales event has expired, at step 420, the online sales event is removed from the online sales application. However, the products that featured in the online sales event may not be deleted from the online sales application after the online sales event has expired.

At step 425, the online sales application 105 provides access to the products through internal channel such as the directed shopping mode 215. In an embodiment, the directed shopping mode allows the user to find products that he or she is interested in. The directed shopping mode GUI includes user interface elements, such as a set of filters, using which the user can specify the particular criterion for finding the products.

Additionally or alternatively, at step 430, the online sales application 105 presents the products in another internal channel such as the online shop 220. In one embodiment, the online shop may be presented as a story in a format similar to that of the online sales event. Further, the online sales application 105 provides access to some of the products in the online shop through third-party applications.

FIG. 5, which includes FIGS. 5A, 5B and 5C, illustrates an example GUI 500 created using the process of FIG. 4, according to an embodiment of the disclosed technique. The GUI 500 presents the story in at least three separate portions, a first portion 505 having story introduction 520, a second portion 510 having a table of contents 525 and a third portion 515 having the chapters, such as chapter “Golf” 530, “Fishing” 532, etc. and characters (such as character 555 of FIG. 5B) within each of the chapters. The GUI 500 also includes a scroll bar 540 that allows the user to scroll the GUI 500, for example, to view various chapters.

The story introduction 520 represents a particular sale event and can include information such as a name of the story, a set of words associated with the story, an image, a video, an audio, or any combination thereof that describes the story. For example, the name of the story can be “Father's Day,” the set of words describing the story can be “Make your father proud of you,” etc. In at least some embodiments, the story introduction 520 can also include details such as the duration for which the story (or the sales event) is available to the users. The story introduction 520 can also be presented with various background images, colors etc. to make the GUI 500 more attractive.

The table of contents 525 identifies various chapters of the story. The chapters are identified by their corresponding names. In the example of GUI 500, the table of contents 525 includes the chapters “Golf,” “Fishing,” “Board,” “Electronics” and “Apparel.” In other embodiments, the table of contents 525 can also include images (or a combination of various multimedia content) that identify the chapters. Further, each of the chapters in the table of contents 525 is configured to navigate to a particular chapter in the third portion 515, for example, when the user selects a chapter from the table of contents 525. For example, when a user selects “Electronics” chapter from the table of contents 525, the GUI 500 presents the “Electronics” chapter to the user. In order to facilitate navigation to a particular chapter based on the user selection of the chapter, each of the chapters in the table of contents 525 can be generated as a hyperlink, a button, etc. that navigates to a particular chapter upon user selection.

Further, in the table of contents 525, the particular chapter the user is currently viewing can be highlighted. For example, the name of the chapter the user is viewing or clicked on can be presented in a different color, bold text, etc. or in any other way that distinguishes the chapter the user is viewing from other chapters in the table of contents 525. In an embodiment, this would help the user identify the particular chapter of the story the user is viewing in the third portion 515.

In the example of GUI 500, the table of contents 525 is generated as a horizontal header strip. Further, the table of contents 525 is presented immediately below the story introduction 520. When the user scrolls the GUI 500 down, for example, to view the chapters that are not in the viewable area, the contents of the GUI 500, including story introduction 520 and table of contents 525, move up and therefore, the table of contents 525 may move out of the viewable area. In an embodiment, the viewable area is the area of a window that displays the GUI 500 to the user. If the user does not have access to the table of contents 525, it may be inconvenient to the user since the user may have to scroll all the way up until the table of contents 525 is visible again to access the table of contents 525 to select an another chapter. Accordingly, in at least some embodiments, the table of contents 525 is configured to be persistent at a particular position relative to the GUI 500 against scrolling of the GUI 500.

For example, the table of contents 525 can be configured to be persistent at the top most part 542 of the GUI 500, as shown in FIG. 5B. For example, when the user scrolls the GUI 500 up, using the scroll bar 540, to view chapter “Fishing” 532, the table of contents 525 initially scrolls up with the GUI 500, and once the table of contents 525 reaches the top 542 of the GUI 500, it will be persistent at the top 542 position to further scrolling. The chapters in the third portion 515 scroll through the table of contents 525. This way the user can access the table of contents 525 regardless of which particular portion or chapter the user is currently at.

In another example, the table of contents 525 can be configured to be persistent at a position such as below the first portion 505, as shown in FIG. 5A. In such a case, the story introduction 520 and the table of contents 525 remain persistent at their current position even when the GUI 500 is scrolled up/down.

In other embodiments, the table of contents 525 can be configured to be persistently accessible by the user in various other ways. For example, the table of contents 525 can be configured to appear as a pop-up window when the table of contents 525 on the GUI 500 scrolls out of the viewable area. Further, the pop-up window can be configured to be moved, by the user, to any position of the screen of the user device. The look-and-feel of the pop-up window can be made consistent with look-and feel of the table of contents 525 in the GUI 500. Having the table of contents 525 always accessible, regardless of which portion of part of GUI 500 the user is currently at, enables the user to navigate to any chapter from any chapter at any point of time without having to scroll to the initial position to access the table of contents 525.

The chapters such as Golf 530 are displayed in the third portion 515 below the table of contents 525. The user may view the chapters that are not in the viewable area (for example, below bottom 544 of the GUI 500) by scrolling the GUI 500 using the scroll bar 540. For example, in the GUI 500, the chapter “Apparel” is not visible in the third portion 515. The user may view this chapter by either scrolling the GUI 500 using the scroll bar 540 or selecting the chapter “Apparel” from the table of contents 525.

The chapters can be presented in the third portion 515 in various orders. In at least some embodiments, the order of the chapters may be determined on various criteria. For example, a user preference is one such criterion. The chapters that a user has indicated as “interesting” may be presented higher in order than chapters that user has not indicated or indicated as “not-interesting.” Further, in some embodiments, the chapters that the user has indicated as “not-interesting” may not be included in the story. In another example, chapters may be sorted based on alphabetical order. It should be noted that the sorting criteria of chapters is not limited to the above examples.

In at least some embodiments, the order of the chapters can be configured by the user. For example, the user may change the order of the chapters by moving the chapter “Electronics” to the first position and “Golf” to the third position, etc. In some embodiments, the e-commerce entity 105 may provide a settings option (not shown) in the GUI 500 where the user can configure the order of the chapters. In other embodiments, the user may change the order of the chapters by changing the order of the chapters in the table of contents 525 using a “drag-and-drop” technique. In response to the change in order of the chapters in the table of contents 525, the GUI 500 automatically updates the order of the chapters in the third portion 515.

In yet another embodiment, the GUI includes a filter such as filter 535 that allows the user to sort the chapters and/or characters within the chapters in a particular order. The filter 535 can include a drop-down menu having a number of options for sorting the chapters and characters. For example, the filter 535 can have an option to sort chapters by name, old to latest, etc. or characters by price, old to latest, color, etc. When the user chooses to sort the characters by price, either from lowest price to highest price or vice versa, the characters within each of the chapters are sorted accordingly. In another embodiment, the filter 535 can also include an option to show characters of a particular color. The user can select one or more options in the filter 535.

Characters are presented in each of the chapters in a particular format and a particular size. FIG. 5B illustrates an example of a format of characters presented in chapter Golf 530. In one embodiment, the characters presented in each of the chapters, such as character 555, can be images of the products. Generally, in a story, some characters are more significant than the others and some characters may need more backstory, introduction, etc. than the others. These characters may be referred to as special characters. The special characters are determined based on a predefined selection criteria, which is described at least with reference to FIG. 3.

The e-commerce entity 105 presents these special characters in a different format than the other characters (non-special characters). In the example 530, a non-special character such as character 555 is presented in a format and size as shown in FIG. 5B. A special character 580 is displayed with an on-character message “Vintage,” as shown in FIG. 5B. The on character-message can be a text, an image, or a combination. In an embodiment, the character 580, which is a vintage product, is determined as a special character since a user has indicated an interest in vintage products. Accordingly, the e-commerce entity 105 presents the special character 580 in a different format. The on-character message can be objective or subjective. An objective on-character message can include a message such as “Vintage” as shown in FIG. 5B. A subjective on-character message can include a message such as “This is a life changing product.”

In another example, a special character such as character 575 can be presented in a larger size. The larger size can be a pre-defined size, for example, size of two non-special characters or four non-special characters, etc.

In another embodiment, special character 565 is presented with a narrative 570. The narrative 570 can include details such as information regarding the product or merchant, a special characteristic of the product, etc. For example, if the character is a furniture product such as a coffee table, the narrative 570 could include information regarding a type of wood used to make the coffee table, whether it is handmade, a particular country it is made in, a name of the designer of the coffee table, etc.

In yet another embodiment, two related characters, such as a laptop and laptop carry bag, may be grouped and presented as a special character such as group 560.

It should be noted that the above embodiments of presenting the special characters are just examples. The GUI 500 may present special characters in various other ways, including in specific colors, backgrounds, borders, a combination of the above, or in any other way so as to distinguish the special characters from non-special characters.

In at least some embodiments, the GUI 500 presents the story in three separate portions. However, in other embodiments, the GUI 500 may present the story in a different number of portions. Further, the GUI 500 presents each of the portions one below the other. However, in other embodiments, the portions may be presented in a different format. For example, the table of contents 525 can be presented as a vertical header strip or a circular strip rather than a horizontal header strip. The vertical header strip can extend from top 542 of the GUI 500 to the bottom 544 of the GUI 500, and the first portion 505 and the third portion 515 can be presented next to the vertical header strip and with the third portion 515 positioned below the first portion 505.

FIG. 5C shows another example of the GUI created using the process of the FIG. 4. In an embodiment, the GUI 590 can be similar to the GUI 500 of FIGS. 5A and 5B. The GUI 590 includes a story introduction 591, which, in an embodiment, is similar to story introduction 520, and a table of contents 592, which, in an embodiment, is similar to table of contents 525. The products offered for sale in the sales event of GUI 590 includes couches. In this example, the story is given the name “SEAT YOURSELF” as shown in story introduction 591. The table of contents 592 includes chapters such as “Slipcovers” 593, “Leather” and “Tailored & Neutral” into which various couches are categorized. The chapters include characters such as character 594 of chapter 593. Each of the various couches is presented as a character in one or more chapters. The GUI 590 also includes special characters such as special character 595, which is larger in size than non-special characters such as character 594. The special character 595 also includes a narrative 596.

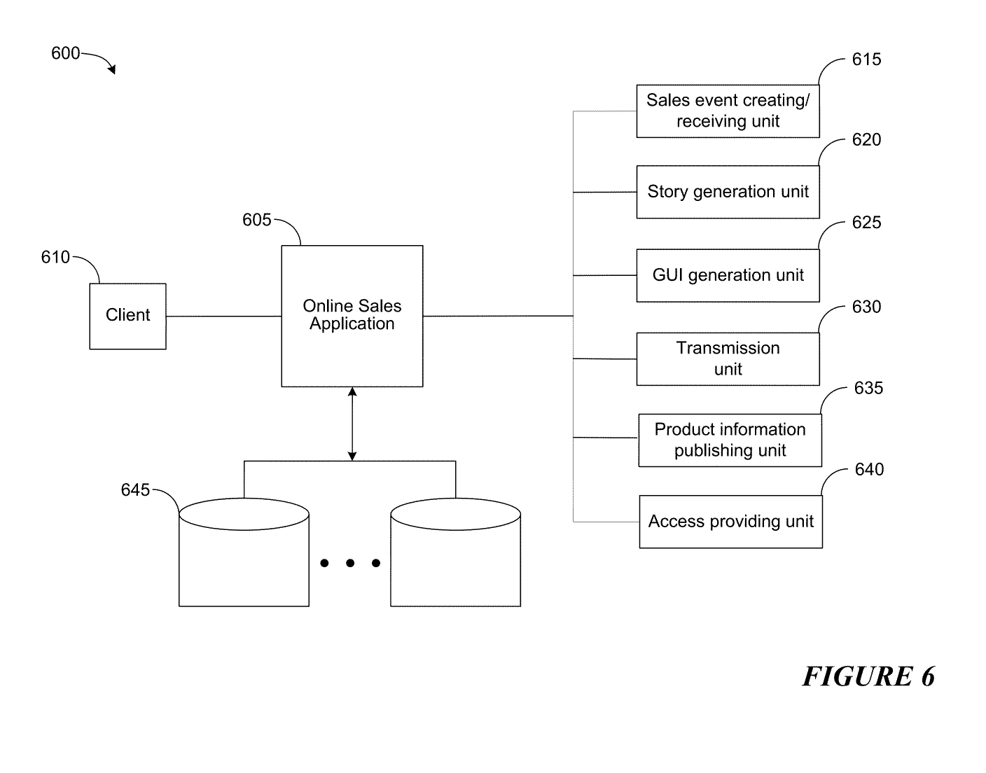

FIG. 6 is a block diagram of a system for generating the GUI for presenting the sales event as a story, according to an embodiment of the disclosed technique. The system 600 includes an online sales application 605 that offers a number of products for sale to consumers such as client 610. In an embodiment, the online sales application 605 is similar to online selling entity 105 of FIG. 1. The online sales application 605 includes a sales event creating/receiving unit 615 that creates or receives an online sales event of a number of products; a story generation unit 620 that creates a story for the sales event; a GUI generation unit 625 that generates a number GUIs to present the products for sale in various channels; a transmission unit 630 that transmits the generated GUI to the client 610; a product information publishing unit 635 that publishes product information of products from expired online sales event to third-party applications; and an access providing unit 640 that provides access to the products in the online sales application 605 via various channels.

The sales event creating/receiving unit 615 creates or receives a sales event of a number of products. In an embodiment, the sales event creating/receiving unit 615 receives an online sales event from a particular vendor or merchant and includes products from that particular merchant for sale. In another embodiment, the online sales application 605 may create its own online sales event which includes products manufactured by or for the online sales entity 605, from one or more merchants, or a combination. The sales event creating/receiving unit 615 also ensures that the sales events are offered to clients 610 as per predetermined sales strategies of the online sales application 605 and/or vendors. For example, if a particular online sales event is offered only for a predefined period, the sales event creating/receiving unit 615 ensures that the online sales event is not made available to the user after the expiry of the predefined period.

The story generation unit 620 generates a story for the online sales event. The story generation unit 620 obtains the necessary information for creating the story from the storage system 645. In an embodiment, the storage system 645 is similar to the storage system 125 of FIG. 1. The access providing unit 640 determines how and when to provide access to products in the online sales application 605. For example, the access providing unit 640 ensures that the access to a set of products featured in a given online sales event is offered exclusively through the online sales application 605 until the online sales event expires. In another example, the access providing unit 640 provides access to the products from expired online sales events through the directed shopping mode or the online shop. In yet another example, the access providing unit 640 provides access to the products from expired online sales events through third party applications.

The product information publishing unit 635 publishes product information of products from expired online sales events to the third-party applications. In an embodiment, the product information publishing unit 635 publishes the product information to the third party applications as advertisements or as a product listing. The advertisements or product listings can include multi-media content such as a text, an image, a video, an audio clip or a combination that is representative of the products. In an embodiment, the product information publishing unit 635 may use the API of third-party applications for publishing the product information.

The GUI generation unit 625 includes any necessary applications to generate the GUI for presenting the products in the online sales event, the directed shopping mode and/or the online shop. In an embodiment, the GUI generation unit 625 can include applications such as Java, C#, .NET framework, HyperText markup language (HTML), Java Server Pages (JSP), Personal Home Page (PHP). The transmission unit 630 transmits the GUI to the client 610 and the client 610 renders the GUI on its display.

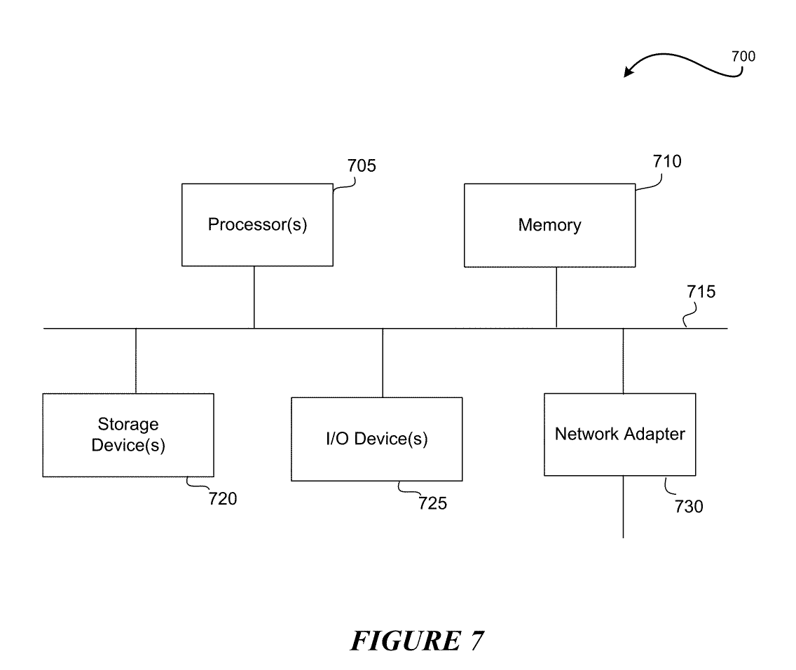

FIG. 7 is a block diagram of an apparatus that may perform various operations, and store various information generated and/or used by such operations, according to an embodiment of the disclosed technique. The apparatus can represent any computer or processing system described herein. The processing system 700 is a hardware device on which any of the entities, components or services depicted in the examples of FIGS. 1-6 (and any other components described in this specification), such as clients 110 or 610, online selling entity 105 or 605, sales event creating/receiving unit 615, story generation unit 620, GUI generation unit 625, etc. can be implemented. The processing system 700 includes one or more processors 705 and memory 710 coupled to an interconnect 715. The interconnect 715 is shown in FIG. 7 as an abstraction that represents any one or more separate physical buses, point to point connections, or both connected by appropriate bridges, adapters, or controllers. The interconnect 715, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 705 is/are the central processing unit (CPU) of the processing system 700 and, thus, control the overall operation of the processing system 700. In certain embodiments, the processor(s) 705 accomplish this by executing software or firmware stored in memory 710. The processor(s) 705 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 710 is or includes the main memory of the processing system 700. The memory 710 represents any form of random access memory (RAM), read-only memory (ROM), flash memory, or the like, or a combination of such devices. In use, the memory 710 may contain a code. In one embodiment, the code includes a general programming module configured to recognize the general-purpose program received via the computer bus interface, and prepare the general-purpose program for execution at the processor. In another embodiment, the general programming module may be implemented using hardware circuitry such as ASICs, PLDs, or field-programmable gate arrays (FPGAs).

Also connected to the processor(s) 705 through the interconnect 715 are a network adapter 730, a storage device(s) 720 and I/O device(s) 725. The network adapter 730 provides the processing system 700 with the ability to communicate with remote devices, over a network and may be, for example, an Ethernet adapter or Fibre Channel adapter. The network adapter 730 may also provide the processing system 700 with the ability to communicate with other computers within the cluster. In some embodiments, the processing system 700 may use more than one network adapter to deal with the communications within and outside of the cluster separately.

The I/O device(s) 725 can include, for example, a keyboard, a mouse or other pointing device, disk drives, printers, a scanner, and other input and/or output devices, including a display device. The display device can include, for example, a cathode ray tube (CRT), liquid crystal display (LCD), or some other applicable known or convenient display device.

The code stored in memory 710 can be implemented as software and/or firmware to program the processor(s) 705 to carry out actions described above. In certain embodiments, such software or firmware may be initially provided to the processing system 700 by downloading it from a remote system through the processing system 700 (e.g., via network adapter 730).

The techniques introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

Software or firmware for use in implementing the techniques introduced here may be stored on a machine-readable storage medium and may be executed by one or more general-purpose or special-purpose programmable microprocessors. A “machine-readable storage medium”, as the term is used herein, includes any mechanism that can store information in a form accessible by a machine.

A machine can also be a server computer, a client computer, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

A machine-accessible storage medium or a storage device(s) 720 includes, for example, recordable/non-recordable media (e.g., ROM; RAM; magnetic disk storage media; optical storage media; flash memory devices; etc.), etc., or any combination thereof. The storage medium typically may be non-transitory or include a non-transitory device. In this context, a non-transitory storage medium may include a device that is tangible, meaning that the device has a concrete physical form, although the device may change its physical state. Thus, for example, non-transitory refers to a device remaining tangible despite this change in state.

The term “logic”, as used herein, can include, for example, programmable circuitry programmed with specific software and/or firmware, special-purpose hardwired circuitry, or a combination thereof.

What is claimed is:

1. A method comprising:
creating an online sales event in an online sales application, the online sales event created based on a concept and offering for sale a plurality of products related to the concept, wherein the online sales event does not allow searching for a particular product within the online sales event using a search query, and wherein the online sales event is valid for a predefined duration;
providing access to the products featured in the online sales event exclusively via the online sales event for the predefined duration; and
upon expiry of the predefined duration,
removing the online sales event from the online sales application, and
providing access to the products that featured in the online sales event via a third-party application.

2. The method of claim 1, wherein the third-party application includes at least one of (i) a third-party online retailer, (ii) a third-party search-engine results page, (iii) an online directory listing of merchants, (iv) a social networking site, or (v) a blogging site.

3. The method of claim 1, wherein providing access to the products featured in the online sales event via the third-party application includes displaying information related to the products in the third-party application.

4. The method of claim 3, wherein displaying information related to the products in the third-party application includes displaying at least one of (a) an advertisement of one or more of the products or (b) a link to the one or more of the products.

5. The method of claim 3 further comprising:
presenting, in response to a user selection of the information in the third-party application, a first graphical user interface (GUI) of the online sales application displaying the products of an expired online sales event.

6. The method of claim 5, wherein the first GUI includes a set of filters that allows the user to define a particular criterion for searching the products.

7. The method of claim 1, wherein creating the online sales event includes
creating the online sales event as a story, the story including a plurality of chapters, each of the chapters representing a particular relationship between the products and including a set of related products from the products, and each of the products represented as a character of the story in at least one of the chapters.

8. The method of claim 7, wherein the concept of the online sales event or the story is based on at least one of (i) a theme, (ii) an occasion, or (iii) an event.

9. The method of claim 7, wherein providing access to the products exclusively via the online sales event includes
generating the online sales event in a second GUI in the form of the story, the GUI including at least (i) a story introduction, (ii) a table of contents identifying the chapters of the story, and (iii) each of the chapters having corresponding set of related products as the characters, and
serving, in response to a request from the user, the second GUI to the user.

10. The method of claim 9 further comprising:
rendering, at a client device, the second GUI for display to the user.

11. The method of claim 9, wherein the second GUI further includes
at least a first portion, a second portion and a third portion,
the first portion displaying the story introduction,
the second portion displaying the table of contents, the table of contents rendered as a header strip, the chapters displayed discretely in the header strip, the header strip configured to be persistent at a predefined position even in response to scrolling the second GUI, and
the third portion including a plurality of sections, each of the sections corresponding to one of the chapters displayed in the header strip, each of the sections displaying the set of related products of the corresponding chapter as a set of characters.

12. The method of claim 9, wherein the story introduction includes at least one of a text or an image representative of the story, wherein the header strip identifies each of the chapters using at least one of a text or an image representative of the corresponding chapter, and wherein each of the set of characters in each of the chapters are displayed using at least one of a text or an image representative of the corresponding product.

13. The method of claim 9, wherein each of the first portion, second portion, and third portion is organized in the second GUI in the order of the first portion, second portion, and third portion.

14. A method comprising:
creating an online sales event of a plurality of products in an online sales application, the online sales event being valid for a predefined duration;
providing access to the products featured in the online sales event to a user exclusively via the online sales event for the predefined duration; and
after the predefined duration,
removing the online sales event from the online sales application, and
performing at least one of
(i) providing access to all of the products featured in the online sales event in a directed shopping mode, or
(ii) providing access to a subset of the products featured in the online sales event via an online shop of the online sales application, wherein one or more of the subset of the products in the online shop are accessible via a third-party application.

15. The method of claim 14, wherein providing access in the directed shopping mode includes presenting all of the products in a first graphical user interface (GUI) that displays the products based on a search criterion.

16. The method of claim 15, wherein the first GUI includes a set of filters that allows the user to define the search criterion.

17. The method of claim 14, wherein creating the online sales event includes
creating the online sales event as a story, the story including a plurality of chapters, each of the chapters representing a particular relationship between the products and including a set of related products from the products, and each of the products represented as a character of the story in at least one of the chapters.

18. The method of claim 14, wherein providing access to the products exclusively via the online sales event includes
generating the online sales event in a second GUI in the form of the story, the GUI including at least (i) a story introduction, (ii) a table of contents identifying the chapters of the story, and (iii) each of the chapters having corresponding set of related products as the characters, and
serving, in response to a request from the user, the second GUI to the user.

19. The method of claim 18, wherein providing access via the online shop includes presenting a third GUI, the third GUI being similar in format to the second GUI, and wherein the online shop is not removed from the online sales application after the predefined duration.

20. An apparatus comprising:
a processor;
a sales event creating unit of an online sales application that works in co-operation with the processor to create an online sales event, the online sales event created based on a concept and offering for sale a plurality of products related to the concept, wherein the online sales event does not allow searching for a particular product within the online sales event using a search query, and wherein the online sales event is valid for a predefined duration;
a product information publishing unit that works in cooperation with the processor to publish at least a subset of the products of the online sales event to a third-party application, the product information publishing unit configured to publish the at least subset of the products of the online sales event after the predefined duration; and
an access providing unit that works in cooperation with the processor to provide access to the products featured in the online sales event to a user
exclusively via the online sales event for the predefined duration, and
via a third-party application after the predefined duration.

21. The apparatus of claim 20 further comprising:
a graphical user interface (GUI) generation unit that works in cooperation with the processor to generate a first GUI, wherein the first GUI presents the products featured in the online sales event in the form of a story, the story including a plurality of chapters, each of the chapters representing a particular relationship between the products and including a set of related products from the products, and each of the products represented as a character of the story in at least one of the chapters, and wherein the first GUI is accessible only for the predefined duration.

22. The apparatus of claim 21, wherein the GUI generation unit is further configured to generate a second GUI to present the at least subset of the products after the predefined duration, and wherein the at least subset of products in the second GUI are accessible via the third-party application.

23. The apparatus of claim 22, wherein, at a given instance, a given product of the products is presented either in the first GUI or the second GUI.
